(19) United States
(12) Patent Application Publication
(10) Pub. No.: US 2025/0298685 A1
(43) Pub. Date: Sep. 25, 2025

(54) INCIDENT REMEDIATION

(71) Applicant: INTERNATIONAL BUSINESS MACHINES CORPORATION, Armonk, NY (US)

(72) Inventors: Jonathan Ian SETTLE, Dursley (GB); Jack Richard BUGGINS, London (GB)

(21) Appl. No.: 18/610,179

(22) Filed: Mar. 19, 2024

(51) Int. Cl. G06F 11/07

(52) U.S. Cl. CPC G06F 11/0793; G06F 11/079; G06F 11/0709

(57) ABSTRACT

Methods, computer program products, and systems are presented. The method computer program products, and systems can include, for instance: evaluating alert data received from one or more computer environment in reference to a criterion; detecting that a current incident has occurred based on the criterion being satisfied; performing similarity analysis between the current incident and one or more historical incident; identifying, from the similarity analysis, a match between the current incident and the one or more historical incident; responsively to the identifying of the match, training a predictive model for production of a trained predictive model with use of dataset data of the one or more historical incident and historical text based data describing the one or more historical incident, wherein the historical text based data has been defined by an administrative user.

### BACKGROUND

Embodiments herein relate to remediation in general and specifically to remediation of detected incidents.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: evaluating alert data received from one or more computer environment in reference to a criterion; detecting that a current incident has occurred based on the criterion being satisfied; performing similarity analysis between the current incident and one or more historical incident; identifying, from the similarity analysis, a match between the current incident and the one or more historical incident; responsively to the identifying of the match, training a predictive model for production of a trained predictive model with use of dataset data of the one or more historical incident and historical text based data describing the historical incident, wherein the historical text based data has been defined by an administrative user; querying the trained predictive model subsequent to the training for return of descriptive text based data describing the current incident; and presenting user prompting data for remediation of the current incident, wherein the prompting data includes the descriptive text based data describing the current incident.

In another aspect, a computer program product can be provided. The computer program product can include a computer readable storage medium readable by one or more processing circuit and storing instructions for execution by one or more processor for performing a method. The method can include, for example: evaluating alert data received from one or more computer environment in reference to a criterion; detecting that a current incident has occurred based on the criterion being satisfied; performing similarity analysis between the current incident and one or more historical incident; identifying, from the similarity analysis, a match between the current incident and the one or more historical incident; responsively to the identifying of the match, training a predictive model for production of a trained predictive model with use of dataset data of the one or more historical incident and historical text based data describing the historical incident, wherein the historical text based data has been defined by an administrative user; querying the trained predictive model subsequent to the training for return of descriptive text based data describing the current incident; and presenting user prompting data for remediation of the current incident, wherein the prompting data includes the descriptive text based data describing the current incident.

In a further aspect, a system can be provided. The system can include, for example, a memory. In addition, the system can include one or more processor in communication with the memory. Further, the system can include program instructions executable by the one or more processor via the memory to perform a method. The method can include, for example: evaluating alert data received from one or more computer environment in reference to a criterion; detecting that a current incident has occurred based on the criterion being satisfied; performing similarity analysis between the current incident and one or more historical incident; identifying, from the similarity analysis, a match between the current incident and the one or more historical incident; responsively to the identifying of the match, training a predictive model for production of a trained predictive model with use of dataset data of the one or more historical incident and historical text based data describing the historical incident, wherein the historical text based data has been defined by an administrative user; querying the trained predictive model subsequent to the training for return of descriptive text based data describing the current incident; and presenting user prompting data for remediation of the current incident, wherein the prompting data includes the descriptive text based data describing the current incident.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, computer environments. UE devices, and data sources according to one embodiment;

FIGS. 2A-2B depict a flowchart illustrating a method for performance by a manager system according to one embodiment;

FIG. 3 is a diagram depicting a clustering analysis according to one embodiment;

FIG. 4 depicts a prompting user interface according to one embodiment;

FIG. 5 depicts training of a machine learning model according to one embodiment;

FIG. 6 depicts a prompting user interface according to one embodiment; and

FIG. 7 depicts a computing environment according to one embodiment.

### DETAILED DESCRIPTION

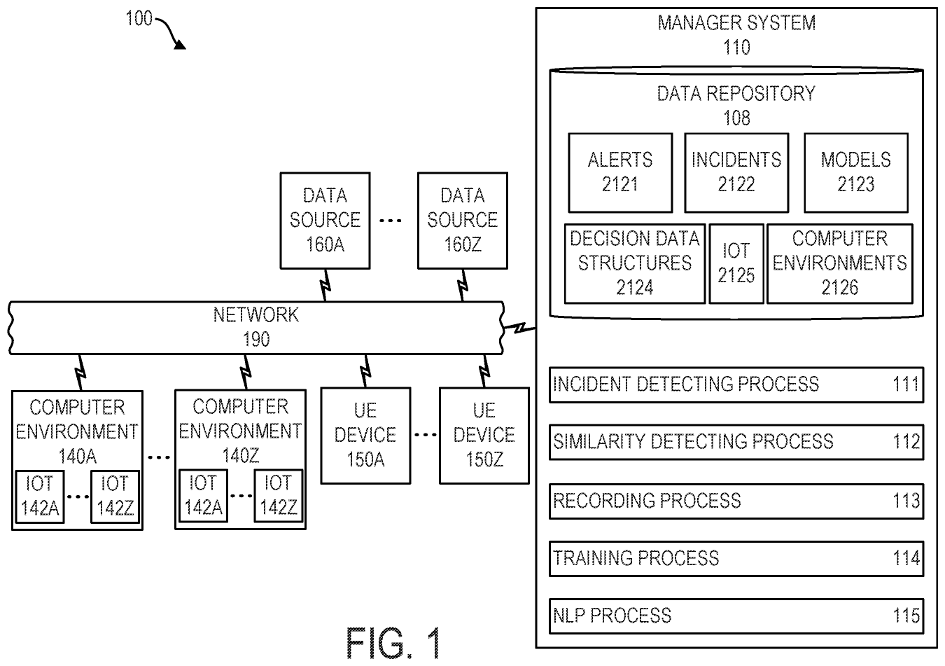

System 100 for use in remediation of incidents is illustrated in FIG. 1. System 100 can include manager system 110 having an associated data repository 108, computer environments 140A-140Z, user equipment (UE) devices 150A-150Z, and data sources 160A-160Z. Manager system 110, computer environments 140A-140Z, UE devices 150A-150Z and data sources 160A-160Z can be in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. With reference to computer environments 140A-140Z, UE devices 150A-150Z and data sources 160A-160Z, the character “Z” can refer to any positive integer.

In one embodiment, manager system 110 can be external from computer environments 140A-140Z, UE devices 150A-150Z and data sources 160A-160Z. In one embodiment, manager system 110 can be co-located with one or more computer environment of computer environments 140A-140Z, one or more UE device of UE devices 150A-150Z and/or one or more data source of data sources 160A-160Z. Embodiments herein can employ machine learning and economized computing resource utilization in the support of reading the remediation of incidents, e.g., information technology (IT) related incidents and/or other industrial incidents, e.g., in an agricultural setting, medical treatment facility, scientific laboratory, e.g., pharmaceutical, biology laboratory setting to name a few. In one aspect, computer environments 140A-140Z can include, respectively, a plurality of information, Internet of things (IoT) devices 142A-142Z.

The respective different UE devices 150A-150Z can be associated to respectively different users, such as administrator users. Regarding one or more UE devices 150A-150Z, a UE device of one or more UE devices 150A-150Z, in one embodiment, can be a computing node device provided by a client computer, e.g., a mobile device, e.g., a smartphone or tablet, a laptop, smartwatch or PC that runs one or more program, e.g., including a web browser for opening and viewing web pages.

Embodiments herein recognize that while machine learning have the potential to provide high accuracy identification of incidents in an industrial setting, machine learning proposals can be encumbered by excessive utilization of computing resources which can both reduce expected lifespan of computing resource hardware and also lengthen response time. In one example, a proposal involving machine learning can include provisions for training epochs involving massive iterations of applied training data that can encompass days, weeks or even months of training before the trained system can be placed online. In one aspect, embodiments herein can employ one or more pre-tech trained machine learning which is pre-trained to feature significant capability, but which can be selected to be free of the need to be extensively trained once placed online in support of an online system.

Data repository 108 can store various data. Data repository 108 in alerts area 2121 of data repository 108 can store data on alerts identified by system 100. Alerts can be identified at computer environments 140A-140Z and/or by manager system 110 processing unstructured alert data received from computer environments 140A-140Z. Alerts herein can be defined by a dataset that comprises various data including alert type, a timestamp and a location. Data repository 108 in incidents area 2122 can store data specifying incidents that have been recognized by system 100. Manager system 110 can be configured to detect incidents based on an examining of plurality of alerts recorded in alerts area 2121.

Data repository 108 in models area 2123 can store large language models (LLMs) that have been received by manager system 110 as well as other models.

Manager system 110 can be configured to iteratively, e.g., on a timed basis receive updated LLMs from one or more data source of data sources 160A-160Z. Such updated LLMs can be stored in models area 2123. In one embodiment, data repository 108 in models area 2123 can store plurality of LLMs, e.g., for different languages or different subject matter domains. For example, models area 2123 can store a first LLM trained in an IT domain and a second LLM trained in a biology domain. Models area 2123, in one embodiment, can support a foundation model architecture. According to a foundation model architecture, system 100 can include one or more foundation model and one or more specific task model. The one or more specific task model can be provided by application of limited training data to the foundation model (e.g., in a few shot training process, which in one embodiment can be a one shot training process).

Data repository 108 in decision data structures area 2124 can store decision data structures for use in return of action decisions by manager system 110. Decision data structures can include, e.g., decision tables and decision trees.

Data repository 108 in IoT area 2125 can store data on IoT devices of system 100. For example, there can be stored in IoT area 2125 data on IoT device type, maintenance records, software version records and the like.

Data repository 108 in computer environment area 2126 can store data on computer environments 140A-140Z being monitored by system 100 for occurrence of incidents. For example, there can be stored in computer environments area 2126 data on computing nodes and applications running within the computing environments. There can also be stored in computer environments area 2126 installation software (e.g., version upgrades) for operating computing nodes of the respective computer environments, including IoT devices therein. In remediation modes, such installation software can be selectively installed on certain computing nodes of computer environments subject to remediation including IoT devices. Manager system 110 can be configured to run various processes.

In performance of incident detecting process 111, manager system 110 can iteratively query computer environments 140A-140Z being monitored for return of alert data. Alert data sent by computer environments 140A-140Z can be generated in dependence on output data output from IoT devices 142A-142Z of the respective computer environments 140A-140Z. Alert data sent by computer environments 140A-140Z can comprise, in one example, alert datasets specifying alerts detected by a respective computer environment of computer environments 140A-140Z. In another example, alert data can be sent and received in the form of unstructured alert data, e.g. unstructured IoT data.

Where manager system 110 receives unstructured alert data, manager system 110 can process the received unstructured alert data for identification of an alert and corresponding generation of an alert dataset specifying the alert.

Manager system 110 running incident detecting process 111 can include manager system 110 detecting incidents within an environment being monitored. Manager system 110 running incident detecting process 111 can include manager system 110 examining alert dataset data stored in alerts area 2121. Manager system 110 running incident detecting process 111 can include manager system 110 examining alert dataset data to determine whether an incident detecting criterion has been satisfied. Incident detecting criterion can include, e.g., that a specified type of alert has been observed, a specified type of alert has remained active for a specified duration, a specified combination of alerts has been observed and the like.

Manager system 110 running similarity detecting process 112 can include manager system 110 comparing dataset data of a currently detected incident to dataset data of one or more historical incident stored in incidents area 2122. For each incident stored in incidents area 2122, data repository 108 can store an incident dataset. Manager system 110 running similarity detecting process 112 can perform extracting of parameter values from incident datasets of historical incidents stored in incidents area 2122. An incident dataset can include a plurality of alert datasets recorded as triggering detection of the incident. An alert dataset can trigger detection of an incident where processing of alert data defining the alert dataset results in an incident detecting criterion being satisfied.

Manager system 110 performing incident detecting process 111 can include manager system recording in incidents area 2122 an incident dataset when an incident has been detected. An incident dataset can include a plurality of alert datasets. Alert datasets recorded to define an incident dataset can comprise the alert datasets of alerts examined by manager system 110 for determination of whether an incident criterion has been satisfied.

Manager system 110 running similarity detecting process 112 can include manager system 110 comparing the current incident dataset to one or more historical incident dataset. Manager system 110 running similarity detecting process 112, in one embodiment, can include manager system 110 performing clustering analysis in comparing the current incident dataset to one or more historical incident datasets. Manager system 110 performing similarity detecting process 112 can include manager system 110 performing clustering analysis in comparing the current incident dataset to one or more historical incident datasets. Manager system 110 performing similarity detecting process 112 can include manager system 110 performing shape analysis in comparing the current incident dataset to one or more historical incident datasets.

Manager system 110 running recording process 113 can include manager system 110 presenting prompting data to a user prompting the user to enter text based data describing an incident that has been detected. Manager system 110 responsively to presenting the described prompting data can record user defined responsive text based data describing the detected incident. Manager system 110 on the receipt of user defined text based data describing an incident can record the text based data within incidents area 2122 associated to the incident.

Manager system 110 running training process 114 can include manager system 110 performing limited and computing resource economized training of an LLM. Manager system 110 running training process 114 can include manager system 110 applying training data to an LLM. Manager system 110 running training process 114 can include manager system 110 applying one or more iteration of training data to an LLM. An iteration of training data can include an incident dataset for an incident detected as being similar to a current incident together with a historical text based description of the historical incident. Trained as described, the LLM can be responsive to query data. When queried with query data, the described LLM can output response data. The response data can include text based data specifying a description of the current incident specified by the current incident dataset.

Manager system 110 can run natural language processing (NLP) process 115 to process data for preparation of records that are stored in data repository 108 and for other purposes. Manager system 110 can run NLP process 115 for determining one or more NLP output parameter of a message. NLP process 115 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter.

By running of NLP process 115, manager system 110 can perform a number of processes including one or more of (a) topic classification and output of one or more topic NLP output parameter for a received message, (b) sentiment classification and output of one or more sentiment NLP output parameter for a received message, and/or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Manager system 110 running NLP process 115 can include manager system 110 returning NLP output parameters in addition to those specification topic and sentiment, e.g., can provide sentence segmentation tags, and part of speech tags. Manager system 110 can use sentence segmentation parameters to determine e.g., that an action topic and an entity topic are referenced in a common sentence, for example.

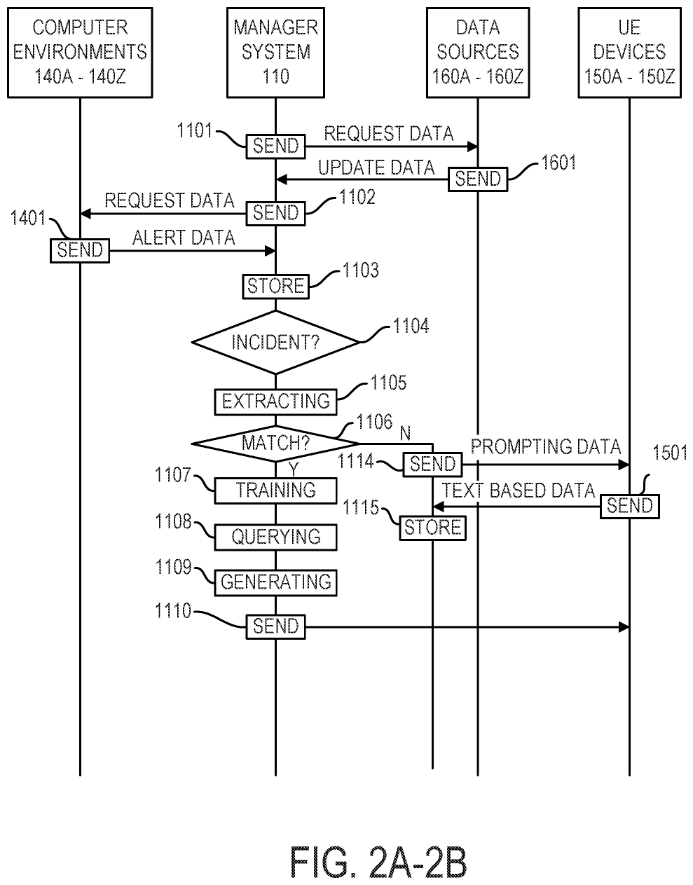

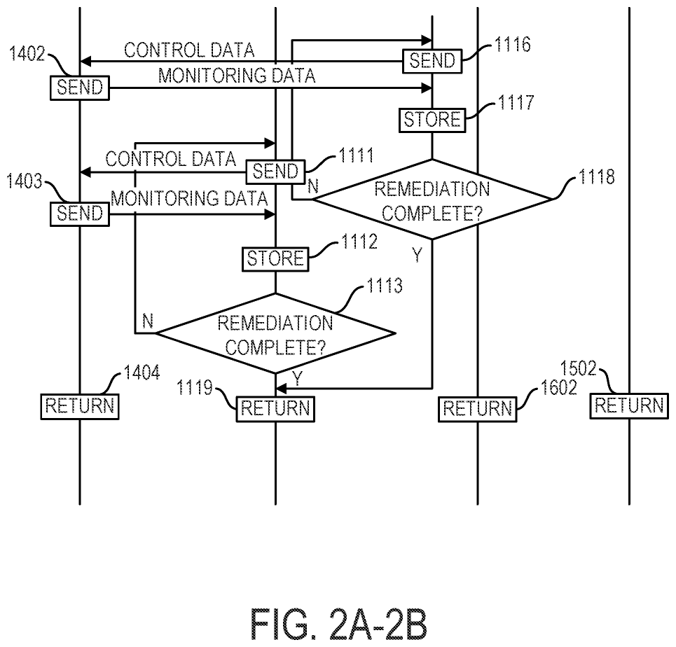

A method for performance by manager system 110 interoperating with computer environments 140A-140Z, UE devices of UE devices 150A-150Z, and data sources 160A-160Z is set forth in reference to the flowchart of FIGS. 2A-2B. At block 1101, manager system 110 can send request data to data sources 160A-160Z requesting updates to any LLM stored in models area 2123, and/or software version upgrades to any computing nodes within computer environments 140A-140Z being monitored with use of IoT devices 142A-142Z.

In response to the request data, data sources 160A-160Z at block 1601 can send update data to manager system 110. On completion of block 1101, manager system 110 at block 1102 can send request data to computer environments 140A-140Z. The request data sent at block 1102 can include request data requesting that computer environments 140A-140Z send any latest alert data to manager system 110. At send block 1401, computer environments 140A-140Z in response to receipt of the described request data sent at block 1102 can send alert data for receipt by manager system 110. Alert data sent by computer environments 140A-140Z can comprise, in one example, alert datasets specifying alerts detected by a respective computer environment of computer environments 140A-140Z. In another example, alert data in the form of unstructured alert data, e.g. unstructured IoT data. Where manager system 110 receives unstructured alert data, manager system 110 can process the received unstructured alert data for identification of an alert and corresponding generation of an alert dataset specifying the alert.

In response to completion of block 1102, manager system 110 can proceed to store block 1103. At store block 1103, manager system 110 can store any received updated LLM into models area 2123. At block 1103, manager system 110 can store into incidents area 2122 any software re-visioning data received in response to send block 1601. At block 1103, manager system 110 can store into alerts area 2121 any alert data received in response to send block 1401.

On completion of store block 1103, manager system 110 can proceed to incident detection block 1104. At incident detection block 1104, manager system 110 can detect whether an incident has been observed. Manager system 110 running incident detection detecting process 111 can include manager system 110 examining alert dataset data to determine whether an incident detecting criterion has been satisfied. Incident detecting criterion can include, e.g., that a specified type of alert has been observed, a specified type of alert has remained active for a specified duration, a specified combination of alerts have been observed and the like.

On completion of incident detection block 1104, manager system 110 can proceed to extracting block 1105. At extracting block 1105, manager system 110 can extract parameter values from incident dataset provided at block 1104.

An example of an incident dataset provided at block 1104 is shown in Table 1.

TABLE 1

| | | | | | | First |
|---|---|---|---|---|---|---|
| Alert ID | State | Summary | Type | Sender | Resource | Occurrence |
| XX | Open | GROUP (8 alert) | 2 types | 1 sender | 4 resources | 18 Jul. 2023, |
| | | LAG failure on | | | | 13:37:38 |
| | | nyca01 [port | | | | |
| | | 1/1/22] | | | | |
| XX | Open | LAG failure on | LAG | Cell | nyca01 | 18 Jul. 2023, |
| | | nyca01 [port | | equipment | | 13:37:38 |
| | | 1/1/22] | | | | |
| XX | Open | LAG failure on | LAG | Cell | rchmdre01 | 18 Jul. 2023, |
| | | rchmdre01 [Port | | equipment | | 13:37:38 |
| | | 10/2/1] | | | | |
| XX | Open | LAG failure on | LAG | Cell | nyca01 | 18 Jul. 2023, |
| | | nyca02[Port | | equipment | | 13:37:38 |
| | | 2/1/22] | | | | |
| XX | Open | LAG failure on | LAG | Cell | rchmdre01 | 18 Jul. 2023, |
| | | rchmdre01 [Port | | equipment | | 13:37:38 |
| | | 10/1/1] | | | | |
| XX | Open | LAG failure on | LAG | Cell | rchmdre01 | 18 Jul. 2023, |
| | | rchmdre01 [Port | | equipment | | 13:37:38 |
| | | 10/2/2] | | | | |
| XX | Open | Mttrapd- | Optical | Cell | RCHMDFBOP01 | 18 Jul. 2023, |
| | | FUJITSU - Loss | Link | equipment | | 13:37:38 |
| | | of Signal on | | | | |
| | | RCHMDFBOP01 | | | | |
| XX | Open | Mttrapd- | Optical | Cell | NYFBBOP01 | 18 Jul. 2023, |
| | | FUJITSU - Loss | Link | equipment | | 13:37:38 |
| | | of Signal on | | | | |
| | | NYFBOP01 | | | | |
| XX | Open | LAG failure on | LAG | Cell | nyca01 | 18 Jul. 2023, |
| | | nyca01 [port | | equipment | | 13:37:38 |
| | | 8/1/22] | | | | |

Referring to Table 1, an incident dataset can include a plurality of alert datasets that triggered the detection of an incident. The respective alert datasets of the plurality of alert datasets can include, e.g., parameter values specifying alert type, alert location and time stamp. Manager system 110 can include an alert dataset within an incident dataset where the alert specified by the alert dataset has triggered satisfaction of a criterion for detection of an incident.

Extracting at block 1105 can include extracting of parameter values for performance of similarity analysis of the current incident detected at block 1104 to one or more historical incident, at match block 1106. For comparison of the current incident detected at block 1104 to one or more historical incident, manager system 110 can compare an incident dataset for current incident to one or more historical incident datasets associated to respective historical incidents. On completion of extracting block 1105, manager system 110 can proceed to match detection block 1106. At match detection block 1106, manager system 110 can perform similarity detection in accordance with similarity detecting process 112.

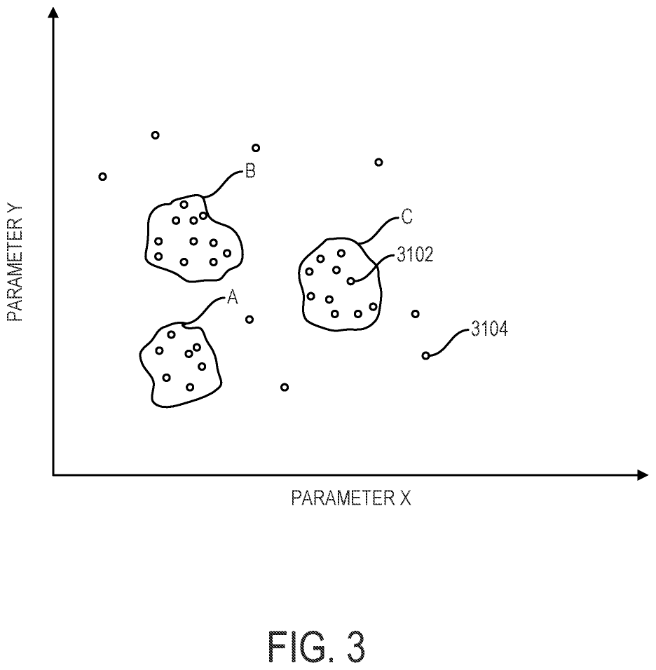

Manager system 110 performing similarity analysis matching according to one technique is illustrated with reference to the clustering analysis diagram of FIG. 3. Manager system 110 performing clustering analysis is described in reference to the clustering analysis diagram of FIG. 3. For performance of clustering analysis, according to one embodiment, manager system 110 can, for a given detected incident, plot the count of first alert types for a given incident against the count of second alert types for the given incident. In reference to the clustering analysis diagram of FIG. 3, vector data point 3102 and vector data point 3104 can be possible data points for a new incoming detected incident where the recorded vectors are counts of an alert of the first type (parameter X) against counts of alerts of the second type (parameter Y). The data points 3102 and 3104 are current possible alternative data points representing the current incoming detected incident whereas remaining data points indicated in FIG. 3 are historical data points representing historical incidents as stored in data repository 108 in incidents area 2122.

In the example clustering analysis diagram of FIG. 3, parameter X and parameter Y represent dimensions in terms of alert types. However, other dimensions can be selected.

Manager system 110 when performing similarity analysis and matching at block 1106 can compare a vector data point 3102 or vector data point 3104 representing the new incoming detected incident to vectors representing historical incidents as represented by the unlabeled data points of FIG. 3.

With reference to the clustering analysis diagram of FIG. 3, manager system 110 has previously identified three clusters of historical incidents based on historical dataset data, namely cluster A, cluster B and cluster C as indicated in FIG. 3.

In the case that the new incoming incident is represented as the vector data point 3102, manager system 110 at matching block 1106 can determine that the new incoming incident matches one or more historical incident, namely, the one or more historical incident within cluster C of which vector data point 3102 is included. In the case that the new incoming incident is represented as the vector data point 3104, manager system 110 at matching block 1106 can determine that the new incoming incident does not match an historical incident.

Where manager system 110 at block 1106 determines that the incoming incident matches an historical incident, manager system 110 can branch to YES block 1107. Where manager system 110 at block 1106 determines that the incoming incident does not match an historical incident, manager system 110 can branch to NO block 1114.

In reference to the clustering analysis diagram of FIG. 3, manager system 110 can determine that an incoming incident matches an historical incident based on the incoming incident being of a common cluster with an historical incident, e.g., cluster C as depicted in FIG. 3, or, in another example, can determine that the incoming incident matches an historical incident based on the Euclidean distance of the newly detected incident being within a threshold satisfying Euclidean distance. With respect to clustering analysis depicted in reference to FIG. 3, embodiments herein recognize that while the clustering analysis is depicted with respect to first and second dimensions, the number of dimensions can be expanded, e.g., to N dimensions.

From alert data referenced within an incident dataset, system 100 can extract the alert types and create a set of types. The set of types can define the shape of the incident. For the respective shapes, manager system 110 can create textual or other types of embeddings and add such embeddings to the shapes to provide incident representation. For each new detected incident, manager system 110 can provide an incident shape with embeddings and compare the resulting incident representation to historical incident representations associated to historical incidents as stored in data repository 108. In performing the comparison, manager system 110 can find the representation distance between a current incident and all the historical example representations learned by manager system 110. Manager system 110 can find the closest example and can determine whether its strength is above a certain threshold (tunable).

As indicated, manager system 110, at block 1106, where no match of a current incoming incident to an historical incident is found, can branch to NO block 1114. At NO block 1114, manager system 110 can send prompting data to a UE device of UE devices 150A-150Z being used by an administrator user. The administrator user can be the administrator user associated to manager system 110 and/or computer environments 140A-140Z being monitored. The prompting data sent at block 1114 can include prompting data that prompts the administrator user to specify text based data describing the incident detected at the most recent iteration of incident block 1104.

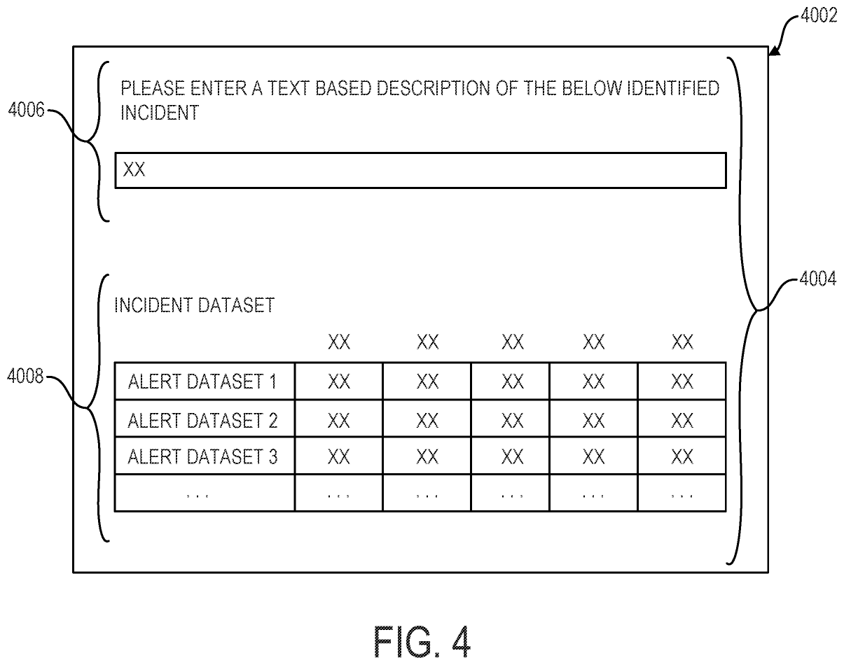

An example of a user interface 4002 for use in entering text based data describing an incident is shown in FIG. 4. The prompting data 4004 sent at block 1114 for presentment on user interface 4002 can comprise prompting data 4006 that includes text based data prompting a user to enter text based data describing the currently detected incident, and an open field (box with “XX” text) permitting an administrator user to enter a text based description of the incident, and text based data 4008 specifying the alert datasets associated to and defining the currently detected incident.

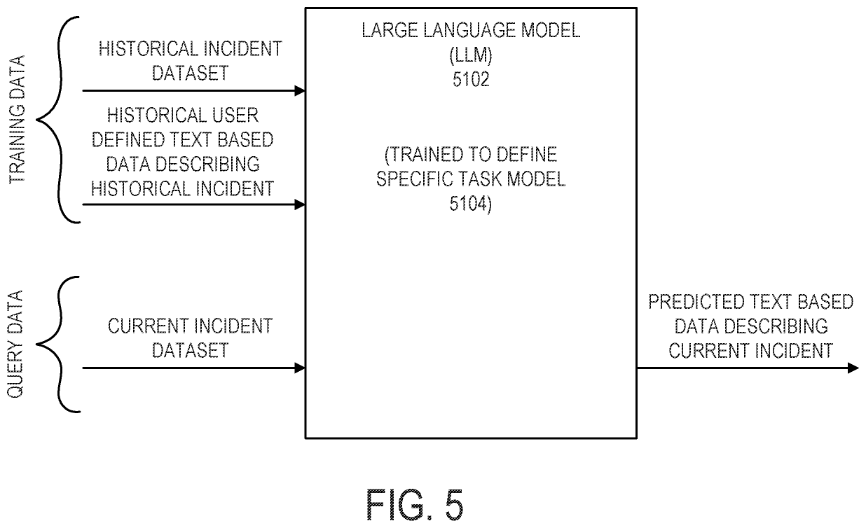

In response to the prompting data, the administrator user can specify text based data describing the detected incident. The administrator user can leverage historical background knowledge of the incident based on familiarity with the relevant computer environments being monitored for detection of an incoming incident. The entered text based data entered into the open field of prompting data 4006 can define training label data for training an LLM for production of a specific task model, as set forth later herein in reference to FIG. 5.

At block 1501, in response to the administrator user defining text based data, the UE device being used by the user can send the user-defined text based data to manager system 110. In response to receipt of the text based data sent at block 1501, manager system 110, at store block 1115, can store text based data within incidents area 2122 of data repository 108, properly referenced to its associated incident as detected at the most recent iteration of block 1104.

In response to completion of store block 1115, manager system 110 can proceed to send block 1116. At send block 1116, manager system 110 can send control data to computer environments 140A-140Z. Control data sent at block 1115 can activate controls to computer environments 140A-140Z to perform monitoring for remediations implemented on in respect to computer environments 140A-140Z in response to the detected incident for which prompting data was presented by administrator user at block 1114.

In response to the receipt of the control data, computer environments 140A-140Z, at send block 1402, can send remediation monitoring data for receipt by manager system 110. The remediation monitoring data sent at block 1402 can include text based data describing remediations performed with respect to computing nodes of computer environments 140A-140Z in response to the detected incident for which prompting data was sent at block 1113. The remediation monitoring data can specify such data items as computing node type subject to remediation, remediation action, and alert type associated to the computing node type. Remediation actions can include, e.g., versioning upgrades, soft reset, hard reset and the like.

The remediation monitoring data sent at block 1402 can be stored by manager system 110 within incidents area 2122 of data repository 108 at store block 1117. On completion of store block 1117, manager system 110 can proceed to decision block 1118. At decision block 1118, manager system 110 can determine whether the current incident detected at the most recent iteration of incident block 1104 has been remediated. Until the time that remediation has been completed, manager system 110 can iteratively perform the loop of blocks 1116-1118. When remediation has been completed, manager system 110 at block 1116 can branch to return block 1119.

Referring again to match decision block 1106, manager system 110 at match decision block 1106 can (in some scenarios) determine that the current incident detected during the most recent iteration of block 1104 matches an historical incident, e.g., is within a common cluster as indicated in FIG. 3 or satisfies a threshold Euclidean distance with respect to an historical incident as described in connection with FIG. 3.

Manager system 110, on determining at block 1106 that a current incident detected at a most recent iteration of incident detection block 1104 matches one or more historical incident, can proceed to training block 1107.

At training block 1107, manager system 110 can perform training of an LLM in order to produce and define a specific task model. With reference to FIG. 5, action decisions of manager system 110 can be provided with use of a foundation model architecture. A foundation model architecture can include one or more foundation model, e.g., which can be provided by an LLM 5102 and one or more specific task model, such as specific task model 5104. In the training scenario depicted in FIG. 5, training of LLM 5102 produces and defines a specific task model 5104, which can be queried for return of predictions.

In one aspect, embodiments herein can employ a pretrained large language model (LLM) defining a foundation model, and system 100 can employ a foundation model architecture. A foundation model architecture can employ one or more foundation model, e.g., an LLM, and one more specific task model, e.g., produced by training of LLM 5102 with limited iterations of training data (e.g., few shot learning, which can include one shot learning).

In reference to FIG. 5, a pre-trained LLM 5102 can be subject to minimal further training for production of a specific task model 5104. In one aspect, LLM 5102 can be pre-trained in the background with unlabeled training data (e.g. by training process performed at a data source of data sources 160A-160Z) and specific task model 5104 can be produced by subjecting LLM 5102 to limited further training with use of labeled training data. The application of limited labeled training data can include few shot training, which according to one example can include one shot training. The described foundation model architecture comprising a division of training data types between LLM 5102 and the specific task model 5104 can provide advantages. In one aspect, embodiments herein recognize that labeling training data can consume significant resources including time resources, and in some cases manual operation resources wherein labeling comprises manual labeling. In one aspect, manually entered text entered into open field 4006 of user interface 4002 can be applied as labeled training data for training LLM 5102 for production of specific task model 5104.

In that LLM 5102 defining a foundation model can be trained without use of labeled training data, LLM 5102 can be pre-trained in the background at high speed and thus, significant volumes of training data can be applied in a short time, leading to accuracy improvements of LLM 5102 over a limited training time. The lack of labels associated to training data for training LLM 5102 can facilitate training of LLM 5102 at high speed with vast amounts of input training data and real time directly from a data source without interruption, e.g., interruption for purposes of applying labels to the input training data. In one embodiment, iterations of training data for training LLM 5102 can include n grams, which can include a succession of words defining a word string. Training data defined by n grams can be applied to LLM 5102 as self-supervised training data, wherein words of word string are broken up (in multiple ways) to LLM 5102 at an input node and an outcome node of LLM 5102 so that LLM 5102 learns a relationship between a first portion and a second portion of a word string.

LLM 5102, in one embodiment, can be pre-trained in the background (prior to deployment and further training by manager system 110 for production of specific task model 5104) using unlabeled datasets saving time and expense associated with manually labeling each item in a large collection of training data.

The described training data for training LLM 5102 can be regarded to be unlabeled training data given that the described training process is absent of applying labels to any training data, and the described process for training LLM 5102 can be regarded to be self-supervised, given that input training image data input into LLM 5102 can be trained on an observation obtained from received n gram word string data used for training (a first portion of a word string can be applied as an input to LLM 5102 and a second portion of the word string can be applied as observed outcome to LLM 5102).

Training data for further training LLM 5102 for producing and defining specific task model 5104, as depicted in FIG. 5 can include a limited amount of training data and training can be performed without user perceivable delay. For production of specific task model 5104, LLM 5102 can be subject to few shot training, which in one embodiment can be provided by one shot training.

LLM 5102 as depicted in FIG. 5 can be provided by a pre-trained LLM. LLM 5102 can be a pre-trained LLM trained with large volumes of data and can employ self-supervised learning to predict the next token in a word string, e.g., sentence, given the surrounding context. Training can be repeated iteratively until the model reaches an acceptable level of accuracy. LLM 5102 can be provided by a machine learning model that can perform a variety of natural language processing (NLP) tasks such as generating and classifying text, answering questions in a conversational manner, and translating text from one language to another. In one embodiment, LLM 5102 can change autonomously millions or billions of parameters as it learns.

A training dataset for training LLM 5102 for production of specific task model 5104 can include, for one or more historical incident matching the current detected incident, (a) the incident dataset, e.g., having the form depicted in Table 1 in combination with (b) the historical administrator user defined text based description of the dataset as defined by an administrator user during a prior historical iteration of block 1501, e.g., text according to the text based data entered in the indicated open field of prompting data 4006 shown in FIG. 4. The historical administrator user defined text based description of the dataset as defined by an administrator user defines a “label” in the limited training data applied for training LLM 5102 to produce and define a specific task model 5104, which can be subject to query for return of prediction data. Training of LLM 5102 for production of specific task model 5104 can include few shot training, which in one example can include one shot training.

In Table 2, there is set forth software code for training of LLM 5102.

TABLE 2
curl ${HOSTSYSTEM}/v1/generate \
-H ‘Content-Type: application/json’ \
-H ‘Authorization: Bearer ${YOUR_API_KEY}’ \
-d ‘{
“model_id”: “model-type/model-id”,
“inputs”: [
“Alerts:[\n{\“summary\”:\“mmtrapd-FUJITSU - loss of signal on
resource\”},\n{\“summary\”:\“mmtrapd-FUJITSU - loss of signal on
SETTLE\”},\n{\“summary\”:\“LAG failure on rchmdre01 [Port
10/2/2]\”},\n{\“summary\”:\“LAG failure on rchmdre01 [Port
10/1/1]\”},\n{\“summary\”:\“LAG failure on settle [Port
1/1/22]\”},\n{\“summary\”:\“LAG failure on settle [Port 8/1/22]\”}\n]”
],
“parameters”: {
“decoding_method”: “greedy”,
“repetition_penalty”: 2,
“min_new_tokens”: 1,
“max_new_tokens”: 200,
“moderations”: {
“hap”: {
“input”: false,
“threshold”: 0.75,
“output”: false
}
}
},
“template”: {
“id”: “prompt_builder”,
“data”: {
“instruction”: “summarise the set of alert json alerts that short”,
“input_prefix”: “Alerts:”,
“output_prefix”: “Text:”,
“examples”: [
{
“input”: “Alerts:[ {\“summary\”:\“mmtrapd-FUJITSU - loss of signal on
ibmdataexcange787\”}, {\“summary\”:\“mmtrapd-FUJITSU - loss of signal on
ELFORD\”}, {\“summary\”:\“LAG failure on ibmdataexcange787 [Port 10/2/2]\”},
{\“summary\”:\“LAG failure on ibmdataexcange787 [Port 1/3/8]\”},
{\“summary\”:\“LAG failure on elford [Port 2/1/89]\”}, {\“summary\”:\“LAG failure on
settle [Port 3/1/89]\”} ]”,
“output”: “Text: There is a fibre cut between ibmdataexcange787 and elford”
}
]
}
}
}’

Produced by training LLM 5102 as described, specific task model 5104 can respond to query data. According to an advantage, the training at training block 1107 can be lightweight and high-speed and can include, e.g., in one embodiment, only a single incident dataset and can leverage the prior historical pretraining of LLM 5102. Training of LLM 5102 for production of specific task model 5104 can include few shot training, which, in one example, can include one shot training. In the use case of Table 2, LLM 5102 is trained with a single historical example dataset in combination with a single historical label. Thus, the described use case of Table 2 is an example of few shot training provided by one shot training. LLM 5102, in another use case for production of specific task model 5104, can be trained with use of a limited number of historical examples (few shot training where there is more than one shot).

At querying block 1108, manager system 110 can perform querying of the produced specific task model 5104 produced by training of LLM 5102 at training block 1107. The querying at block 1108 can include applying query data to specific task model 5104 as described in FIG. 5. Query data for querying specific task model 5104 produced with use of few shot training of LLM 5102 can include applying as query data to specific task model 5104 the current incident dataset associated to the most recently detected incident detected at the most recent iteration of block 1104. Queried as described, specific task model 5104 produced by the few shot training of LLM 5102 at block 1107 can return text based data describing the currently detected incident detected at the most recent iteration of block 1104.

The text based data returned by the querying at block 1108 can be in accordance with the text based data defined by an historical administrator user and described being the historical matching incident, but can be modified in dependence on language differentiators, e.g., entity identifier differentiators, between the historical incident dataset used for training at training block 1107 and the currently detected incident detected at the most recent iteration of block 1104. For example, with the historical incident dataset further trained on the text based description “There is a fibre cut between usedataexcange787 and elford”, the output from specific task model 5104 trained by training LLM 5102 can be the text based output “Fiber Cut between RCH and NY”. According to another example, with the historical incident dataset further trained on the text based description “There is excessive onboarding by ABC INC. customers”, the output from specific task model 5104 trained by training LLM 5102 can be the text based output “Excessive onboarding by BLUE STAR INC. customers”. According to another example, with the historical incident dataset further trained on the text based description “Security attack on XYZ server”, the output from specific task model 5104 trained by training LLM 5102 can be the text based output “Security attack on ABC server”.

On completion of querying block 1108, manager system 110 can proceed to generating block 1109. At generating block 1109, manager system 110 can generate prompting data. On completion of querying block 1108, manager system 110 can proceed to generating block 1109.

At generating block 1109, manager system 110 can generate prompting data for prompting the user to perform remediation in respect to the incident detected at the most recent iteration of block 1104. In one aspect, the prompting data generated at block 1109 can include the text based data returned from specific task model 5104 by the querying of block 1108. The text based data defines prompting data that prompts for remediation at least because the text based data provides a user-friendly description of the current incident detected at the most recent iteration of block 1104.

Further in regard to the generating at block 1109, generating of prompting data can include associating with the text based data describing the current incident, the alert datasets defining the current incident dataset as described in connection with Table 1. The text based alert datasets defining the incident dataset provides the user with further information in regard to the performance of remediations of a detected incident, e.g., including the location of alerts, the timing of alerts and the like. Generating of prompting data at generating block 1109 as shown can include associating with (a) the text based descriptive data describing the current incident and (b) the alert datasets, (c) text based descriptions of remediations performed in the historical one or more incident matching the current incident as detected by the matching at block 1106. The remediation descriptive text can have been stored at a prior historical iteration of store block 1117.

On completion of generating block 1109, manager system 110 can proceed to send block 1110. At send block 1110, manager system 110 can send prompting data to a UE device of the administrator user of UE devices 150A-150Z.

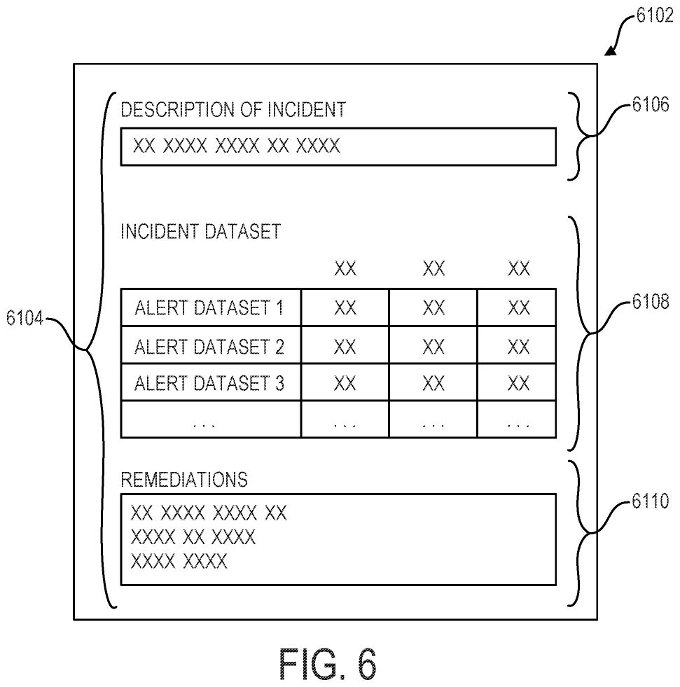

At generating block 1109, manager system 110 can generate prompting data as depicted in the user interface 6102 of FIG. 6. According to FIG. 6, prompting data 6104 can include prompting data 6106 provided by the text based descriptive data of the currently detected incident returned by the querying of block 1108, prompting data 6108 provided by the incident dataset defining the currently detected incident as defined by a plurality of alert datasets, and prompting data 6110 defined by text based descriptive data describing remediations performed in respect to monitored computer environments with respect to an historical incident detected determined to be matching with the currently detected incident detected in the most recent iteration of block 1104. The prompting data 6110 defined by descriptive text of historical remediations further aid the performing of a remediation with respect to the currently detected incident identified as being matching with respect to the historical incident. User interface 4002 (FIG. 4) and user interface 6102 can be displayed user interfaces for display on display of a UE device of UE devices 150A-150Z. User interface 4002 can be presented independent of user interface 6102 or can be co-located with user interface 6102 to define a single user interface.

In response to completion of send block 1110, manager system 110 can proceed to send block 1111. At send block 1111, manager system 110 can send control data for activating monitoring of computer environments 140A-140Z for performance of remediation activities performed with respect to computer environments 140A-140Z. The control data sent at block 1111 can include control data to activate remediation monitoring of computer environments 140A-140Z subject to alert monitoring with the sending of request data at send block 1102. In response to the control data sent at block 1111, computer environments 140A-140Z can return remediation monitoring data at block 1403. In response to the receipt of the control data, computer environments 140A-140Z, at send block 1403, can send remediation monitoring data for receipt by manager system 110. The remediation monitoring data sent at block 1403 can include text based data describing remediations performed with respect to computing nodes of computer environments 140A-140Z in response to the detected incident for which prompting data was sent at block 1113. The remediation monitoring data can specify such data items as computing node type subject to remediation, remediation action and alert type associated to the computing node type. Remediation actions can include, e.g., versioning upgrades, soft reset, hard reset and the like.

With the control data sent at block 1111, manager system 110 can send remediation control data to implement remediations with respect to the newly detected incident detected at a most recent iteration of block 1104 in accordance with the historical remediations performed in respect to the one or more historical incident identified as being matching with the current incident at matching block 1106. For performance of the sending of the remediation control data, manager system 110 can examine the text based data describing historical remediations of the one or more matching historical incident subject to examining at generating block 1109 for generation of prompting data. Based on the examining of text based descriptive data of an historical fault of an historical one or more incident, manager system 110 can generate appropriate executable code with appropriate pointers to files such as installation software (e.g., version upgrades) stored in computer environments area 2126 of data repository 108. Executable code for performance of remediations can define t remediation implementation control data that can be sent with the control data sent at block 1111. On receipt of the remediation implementation control data, computer environments 140A-140Z can perform remediations in accordance with the remediation control data. Such remediations can include, e.g., computing node software version upgrading, soft reset, hard reset, replacement hardware, failing over to a backup system, and like.

To the extent prompting data sent at block 1111 includes text based descriptive data not subject to transformation into remediation control data for sending at block 1111, described mediations can be performed in a non-fully automated matter, e.g., on a human in the loop basis where the human is prompted to perform action based on the presented prompting data 6110. Sending of remediation implementation control data with the control data sent at block 1111 can define a method for automated implementation of remediations.

On completion of blocks 1112 or 1116, manager system 110 can proceed to return block 1117. At return block 1117, manager system 110 can return to a stage preceding block 1101 and manager system 110 can iteratively be performing the loop of blocks 1101-1117 (with the alternative paths of 1113 to block 1116 during a deployment period at manager system 110). Computer environments 140A-140Z can be iteratively performing the loop of blocks 1101 to 1104 during a deployment period of computer environments 140A-140Z. Data sources 160A-160Z can be iteratively performing the loop of blocks 1601 to 1602 during a deployment period of data sources 160A-160Z. UE devices 150A-150Z can be iteratively performing the loop of blocks 1501 to 1502 during a deployment period of UE devices 150A-150Z. Embodiments herein define improvements in computer technology and practical applications at least by the utilization of a pre-trained LLM which can be provisioned for use in remediation with performance of limited additional training, which can be performed without user perceivable delay.

Embodiments herein recognize that artificial intelligence for IT operation (AIops) can include collecting alerts from a vast array of sources with customized rules, i.e., current AIops have no way of knowing the alert it might receive a head of time. AIop's role is to collect/filter/group (correlate) the alerts and present the alerts within a concise way. When alerts are grouped (correlated) together, referred to as an incident (if high enough importance), they are shown (or notified) to the end uses. In current solutions, the group/incident can have many alerts in them. Embodiments herein recognize that current technology for providing notice of such incidents including collections of alerts are of limited use in remediation of incidents. According to current technology, a title of an incident can be based on a parameter value of a single alert within a group of alerts. Embodiments herein recognize that as no single alert describes an incident as a whole, operators must manually look though the alerts to understand what problems are present.

In the example of Table 1, according to an existing approach, the entire incident title can be “Group: LAG failure” based on an individual title. This means the operator has to go into the group and look at the alerts defining to understand the underlying problems triggering the detection of the incident. There can be many reasons for a LAG failure. Embodiments herein recognize that when the administrator user opens the group, they can see the LOS signal loss, and the administrator user may know from experience that means there has been a fiber cut between to 2 sites i.e. “Fiber Cut between RCH and NY”. This becomes harder when there are, e.g., tens to thousands of alerts in the incident. As seen from Table 1, the individual alerts do not reference fiber cut anywhere in text based data of the alerts.

Embodiments herein allow a customer administrator user to enter a descriptive title for the incident, leveraging the user's background knowledge of the meaning of the alerts. In accordance with embodiments herein, manager system 110 will then learn when to apply that title and how to generalize it to a similar problem with different resources with a high degree of accuracy.

When a user names the title of an incident according to one embodiment, manager system 110 can capture all the alerts in the incident and the user-defined title. From the alerts in the incident, system 100 can extract the alert types and create a set of types. The set of types can define the shape of the incident.

For the respective shapes, manager system 110 can create textual or other types of embeddings and add such embeddings to the shapes to provide incident representation. For each new detected incident, manager system 110 can provide an incident shape with embeddings and compare the resulting incident representation to historical incident representations associated to historical incidents as stored in data repository 108. In performing the comparison, manager system 110 can find the representation distance between current incident and all the historical example representations as learning by manager system 110. Manager system 110 can find the closest example and determine if its strength is above a certain threshold (tunable). The use of a comparison threshold gives manager system 110 a high degree of confidence that the target example is relevant to the current incident. Also, the use of the described comparison threshold means the title generation, which is the more expensive step in term of processing time, will only be applied when it will add value.

On the failure to identification matching historical representation, manager system 110 can prompt the user for a descriptive title for the incident.

If there is a matching representation found, data of the incident of the representation can be passed for training of LLM 5102 with a one shot learning for producing specific task model 5104 where the representation, i.e., including title and the associated alerts are the example, and the new incident alert are the entries for summarizing.

Various available tools, libraries, and/or services can be utilized for implementation of a predictive model herein, e.g., LLM 5102, and/or specific task model 5104. For example, a machine learning service can provide access to libraries and executable code for support of machine learning functions. A machine learning service can provide access to sets of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. According to one possible implementation, a machine learning service can provide access to libraries. A machine learning service can provide access to a set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. Predictive models herein can employ, e.g., neural networks, support vector machines (SVM), Bayesian networks, and/or other machine learning technologies.

Certain embodiments herein may offer various technical computing advantages involving computing advantages to address problems arising in the realm of computer systems. Embodiments herein provide accuracy advantages with use of machine learning, and provide for economized utilization of computing resources including hardware and time resources. Computing resource economization can be provided with use of targeted and limited training operations. Embodiments herein further provide improvements to computer technology by way of methods for performance of remediations of incidents detected in respect to a computer environment. Embodiments herein provide for organized detection of matching of a current incident to a prior incident in generation of text based data describing the current incident in dependence on the matching. Remediations can be facilitated not only by text based descriptive data describing an incident but also text based data specifying alerts associated to the detected incident and read it in text based description of remediations of an historical one or more incident matching a current incident. In addition to text based descriptive data facilitating remediation, executable code can be generated for automatic implementation of remediations involving, e.g., software version upgrades, resets and the like. A fundamental aspect of operation of a computer system is its interoperation to which it operates including human actors. By increasing the accuracy and reliability of information presented to human users, embodiments herein increase the level of engagement of human users for enhanced computer system operation. Various decision data structures can be used to drive artificial intelligence (AI) decision making, such as decision data structure that cognitively maps social media interactions in relation to posted content in respect to parameters for use in better allocations that can include allocations of digital rights. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer based analytics and decision making. By leveraging data structures to organize relationships, the techniques described herein can increase efficiency in locating relevant content that can be extracted for presentment to interfaces described herein. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription

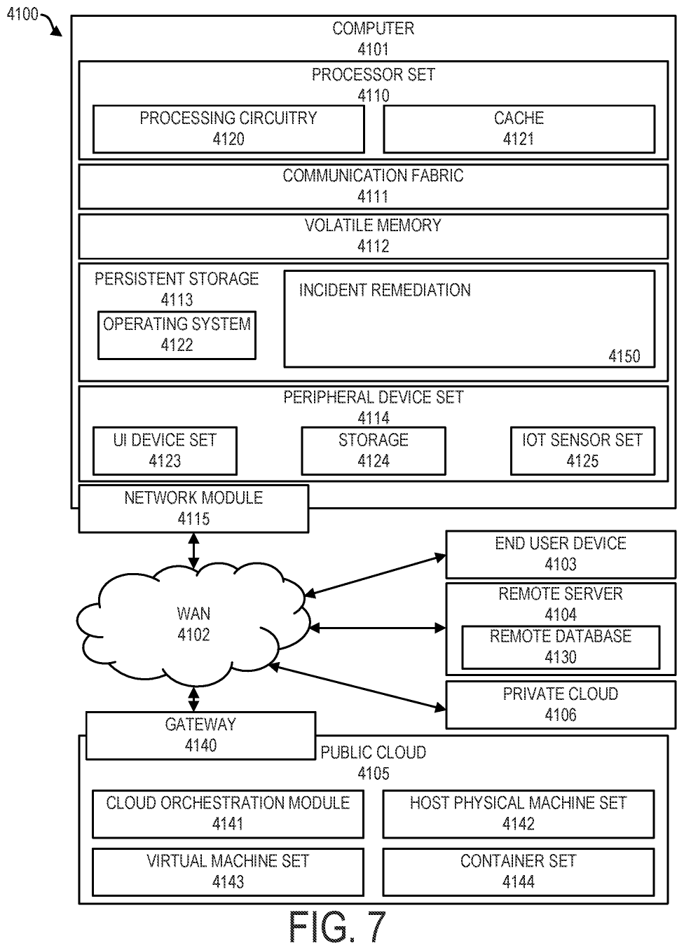

In reference to FIG. 7 there is set forth a description of a computing environment 4100 that can include one or more computer 4101. In one example, computing node 10 as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing incident remediation as described with reference to FIGS. 1-6. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

1. A computer implemented method comprising:
evaluating alert data received from one or more computer environment in reference to a criterion;
detecting that a current incident has occurred based on the criterion being satisfied;
performing similarity analysis between the current incident and one or more historical incident;
identifying, from the similarity analysis, a match between the current incident and the one or more historical incident;
responsively to the identifying of the match, dynamically training a predictive model instance specific to the current incident, for production of a trained predictive model with use of dataset data of the one or more historical incident and historical text based data describing the one or more historical incident, wherein the historical text based data has been defined by an administrative user;
wherein the training is performed using a learning operation that limits model updates to parameters relevant to the matched historical incident to economize computing resources;
querying the trained predictive model subsequent to the training for return of descriptive text based data describing the current incident; and
presenting user prompting data for remediation of the current incident, wherein the prompting data includes the descriptive text based data describing the current incident, wherein the prompting data is presented via a human-computer interface that enables administrator interaction with one or more candidate remediation actions associated with the match,
and wherein the method further includes delivering executable code associated with the one or more candidate remediation actions to the administrator user,
wherein the administrator user is enabled to initiate execution of the executable code such that the current incident is remediated.

2. The computer implemented method of claim 1, wherein performing similarity analysis includes performing clustering analysis.

3. The computer implemented method of claim 1, wherein the prompting data includes alert dataset data and text based data describing remediations performed with respect to the one or more historical incident.

4. The computer implemented method of claim 1, wherein the historical text based data describing the one or more historical incident has been entered by the administrator user responsively to a determination that there is no match between the historical incident and a prior historical incident, the prior historical incident preceding the historical incident.

5. The computer implemented method of claim 1, wherein the method includes transmitting executable code for remediation of the current incident in dependence on the identifying the match between the current incident and the one or more historical incident.

6. The computer implemented method of claim 1, wherein the predictive model is a pre-trained large language model (LLM).

7. The computer implemented method of claim 1, wherein the presenting user prompting data for remediation of the current incident includes presenting text based data describing historical remediations performed with respect to the one or more historical incident.

8. A system comprising:
a memory;
at least one processor in communication with the memory; and
program instructions executable by one or more processor via the memory to perform a method comprising:
evaluating alert data received from one or more computer environment in reference to a criterion;
detecting that a current incident has occurred based on the criterion being satisfied;
performing similarity analysis between the current incident and one or more historical incident;
identifying, from the similarity analysis, a match between the current incident and the one or more historical incident;
responsively to the identifying of the match, training a predictive model for production of a trained predictive model with use of dataset data of the one or more historical incident and historical text based data describing the one or more historical incident, wherein the historical text based data has been defined by an administrative user;
querying the trained predictive model subsequent to the training for return of descriptive text based data describing the current incident; and
presenting user prompting data for remediation of the current incident, wherein the prompting data includes the descriptive text based data describing the current incident.

9. The system of claim 8, wherein performing similarity analysis includes performing clustering analysis.

10. The system of claim 8, wherein the prompting data includes alert dataset data and text based data describing remediations performed with respect to the one or more historical incident.

11. The system of claim 8, wherein the historical text based data describing the one or more historical incident has been entered by the administrator user responsively to a determination that there is no match between the historical incident and a prior historical incident, the prior historical incident preceding the historical incident.

12. The system of claim 8, wherein the method includes transmitting executable code for remediation of the current incident in dependence on the identifying the match between the current incident and the one or more historical incident.

13. The system of claim 8, wherein the predictive model is a pre-trained large language model (LLM).

14. The system of claim 8, wherein the presenting user prompting data for remediation of the current incident includes presenting text based data describing historical remediations performed with respect to the one or more historical incident.

15. (canceled)

16. (canceled)

17. (canceled)

18. (canceled)

19. (canceled)

20. (canceled)

21. A computer implemented method comprising:
evaluating alert data received from one or more computer environment in reference to a criterion;
detecting that a current incident has occurred based on the criterion being satisfied;
performing similarity analysis between the current incident and one or more historical incident;
identifying, from the similarity analysis, a match between the current incident and the one or more historical incident;
responsively to the identifying of the match, training a predictive model for production of a trained predictive model with use of dataset data of the one or more historical incident and historical text based data describing the one or more historical incident, wherein the historical text based data has been defined by an administrative user;
querying the trained predictive model subsequent to the training for return of descriptive text based data describing the current incident; and
presenting user prompting data for remediation of the current incident, wherein the prompting data includes the descriptive text based data describing the current incident.
